(19) United States
(12) Patent Application Publication
(10) Pub. No.: US 2014/0103274 A1
(43) Pub. Date: Apr. 17, 2014

(54) APPARATUS AND METHOD FOR INSTALLING OR REMOVING A CABLE

(71) Applicant: GENERAL ELECTRIC COMPANY, Schenectady, NY (US)

(72) Inventors: Benjamin Edward McDonald, Holliston, MA (US); Mykhaylo Barsukov, Acton, MA (US)

(73) Assignee: General Electric Company, Schenectady, NY (US)

(21) Appl. No.: 13/651,922

(22) Filed: Oct. 15, 2012

(51) Int. Cl. H02G 1/08

(52) U.S. Cl. 254/134.3 R

(57) ABSTRACT

An apparatus and method for installing or removing a cable is disclosed. A cable tool includes a cable channel with two channels having different channel openings for receiving or releasing the cable. The first end of the cable channel has a smaller channel opening and an arm that can be used to remove the cable and disconnect a connector on the end of the cable from a sensor.

### BACKGROUND OF THE INVENTION

The subject matter disclosed herein relates to an apparatus and method for installing or removing a cable, e.g., in a flow cell of a flow meter.

Flow meters, including ultrasonic flow meters, are used to determine the characteristics (e.g., flow rate, pressure, temperature, etc.) of fluids (e.g., liquids, gases, etc.) flowing in pipes of different sizes and shapes. Knowledge of these characteristics of the fluid can enable other physical properties or qualities of the fluid to be determined. In one type of ultrasonic flow meter employing transit time flow metering, one or more pairs of ultrasonic transducers can be installed in or on a flow cell, where each pair can contain transducers located upstream and downstream from each other forming an ultrasonic path between them at a particular chord location across the pipe.

The transducers are installed in sensor ports of the flow cell and are connected via cabling through cable routing channels in the flow cell to a flow meter. The connection and disconnection of connectors for the transducers typically cannot be performed by hand since the connectors of the transducers are recessed too deep into the cavities of the sensor ports. Similarly, the routing of the cables through the cable routing channels cannot be performed by hand and requires one or more customized tools.

The discussion above is merely provided for general background information and is not intended to be used as an aid in determining the scope of the claimed subject matter.

### BRIEF DESCRIPTION OF THE INVENTION

An apparatus and method for installing or removing a cable is disclosed. A cable tool includes a cable channel with two channels having different channel openings for receiving or releasing the cable. The first end of cable channel has a smaller channel opening and an arm that can be used to remove the cable and disconnect a connector on the end of the cable from a sensor. An advantage that may be realized in the in the practice of some disclosed embodiments of the cable tool is that a single tool can be used to install and remove connectors in recessed cavities that are not hand or finger accessible.

In one embodiment, an apparatus for installing or removing a cable is disclosed. The apparatus comprises a first end comprising a cable channel formed from a cable channel wall and having a cable channel opening for receiving or releasing the cable from the cable channel, the cable channel comprising a first channel at a first end of the cable channel formed from a first channel wall and having a first channel opening, the first channel wall forming a first partial circle and having first channel wall arm having a front face and a rear face, and a second channel at a second end of the cable channel opposite of the first end the cable channel formed from a second channel wall and having a second channel opening, the second channel wall forming a second partial circle, wherein the length of the first partial circle of the first channel wall is greater than the length of the second partial circle of the second channel wall by the length of the first channel wall arm extending beyond the second channel wall, and wherein the first channel opening is smaller than the second channel opening.

In another embodiment, the apparatus comprises a first end comprising a cable channel formed from a cable channel wall and having a cable channel opening for receiving or releasing the cable from the cable channel, the cable channel comprising a first channel at a first end of the cable channel formed from a first channel wall and having a first channel opening, the first channel wall forming a first partial circle between 270 and 360 degrees and having a first channel wall arm having a front face and a rear face, wherein the rear face is perpendicular to the longitudinal center axis of the cable channel, and a second channel at a second end of the cable channel opposite of the first end the cable channel formed from a second channel wall and having a second channel opening, the second channel wall forming a second partial circle between 180 and 270 degrees, wherein the length of the first partial circle of the first channel wall is greater than the length of the second partial circle of the second channel wall by the length of the first channel wall arm extending beyond the second channel wall, and wherein the first channel opening is smaller than the second channel opening.

In another embodiment, a method for installing or removing a cable is disclosed. The method comprises the steps of placing a cable channel around the cable, the cable channel formed from a cable channel wall and having a cable channel opening for receiving or releasing the cable from the cable channel, the cable channel comprising a first channel at a first end of the cable channel formed from a first channel wall and having a first channel opening, the first channel wall forming a first partial circle and having first channel wall arm having a front face and a rear face, and a second channel at a second end of the cable channel opposite of the first end the cable channel formed from a second channel wall and having a second channel opening, the second channel wall forming a second partial circle, moving the cable channel in a first longitudinal direction proximate to the distal end of the cable, wherein the cable channel is moved in the first direction while surrounding a portion of the cable, rotating the cable channel, and moving the cable channel in a second longitudinal direction opposite of the first longitudinal direction, wherein the cable channel is moved in the second longitudinal direction while surrounding a portion of the cable at the distal end of the cable causing friction between the rear face of the first channel wall arm and the cable.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a perspective view of the first side of an exemplary flow cell;

FIG. 2 is a perspective view of the second side of the exemplary flow cell;

FIG. 3 is a top view of the top side of the exemplary flow cell;

FIG. 4 is a bottom view of the bottom side of the exemplary flow cell;

FIG. 5 is a cross-section through the exemplary flow cell illustrating the exemplary cable routing channel and sensor ports;

FIG. 6 is a cross-section through the exemplary flow cell illustrating the exemplary cable routing channel and sensor ports;

FIG. 7 is perspective view of an exemplary cable tool for installing or removing a cable in the exemplary flow cell of FIGS. 1-6;

FIG. 8 is an enhanced view of the cable channel of the exemplary cable tool of FIG. 7;

FIG. 9 is a cross-section of the second channel of the exemplary cable channel FIG. 8;

FIG. 10 is a cross-section of the first channel of the exemplary cable channel FIG. 8;

FIG. 11 is an exemplary method for installing or removing a cable using the exemplary cable tool of FIG. 7.

FIGS. 12 and 13 are perspective views of the exemplary cable tool of FIG. 7 as used to install a cable and connect a cable connector to the connector of a sensor;

FIGS. 14 and 15 are perspective views of the exemplary cable tool of FIG. 7 as used to remove the cable and disconnect the cable connector from the connector of the sensor; and

### DETAILED DESCRIPTION OF THE INVENTION

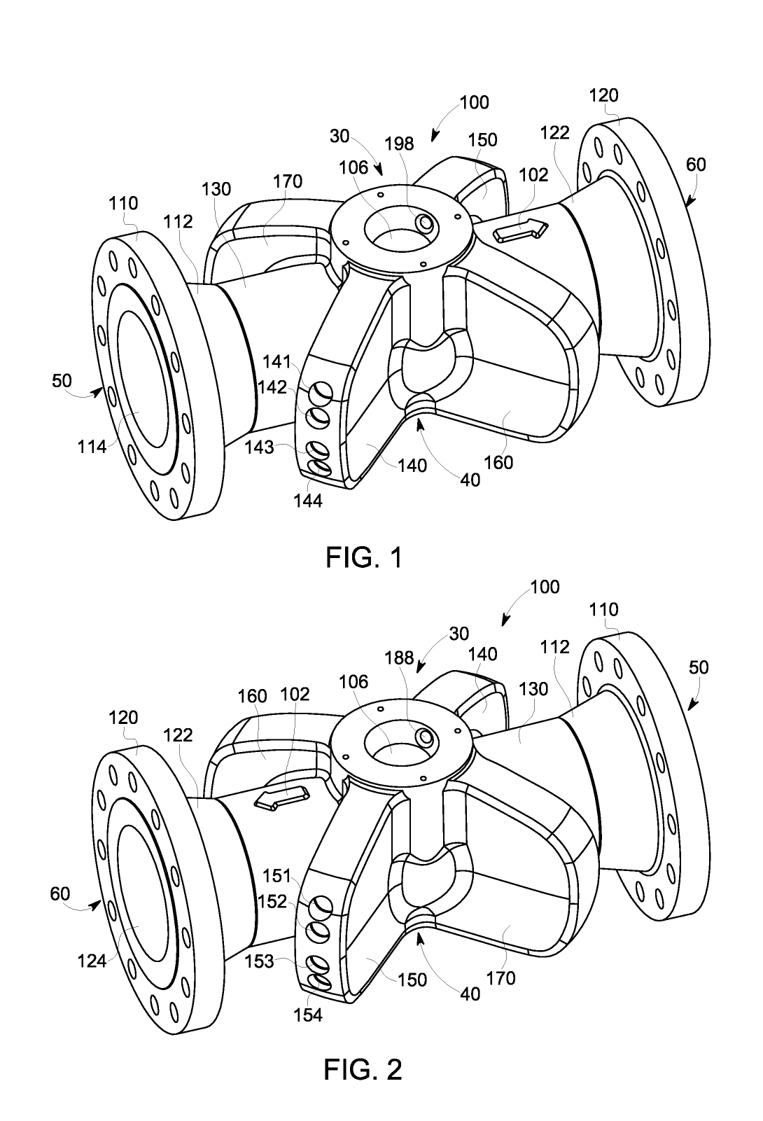

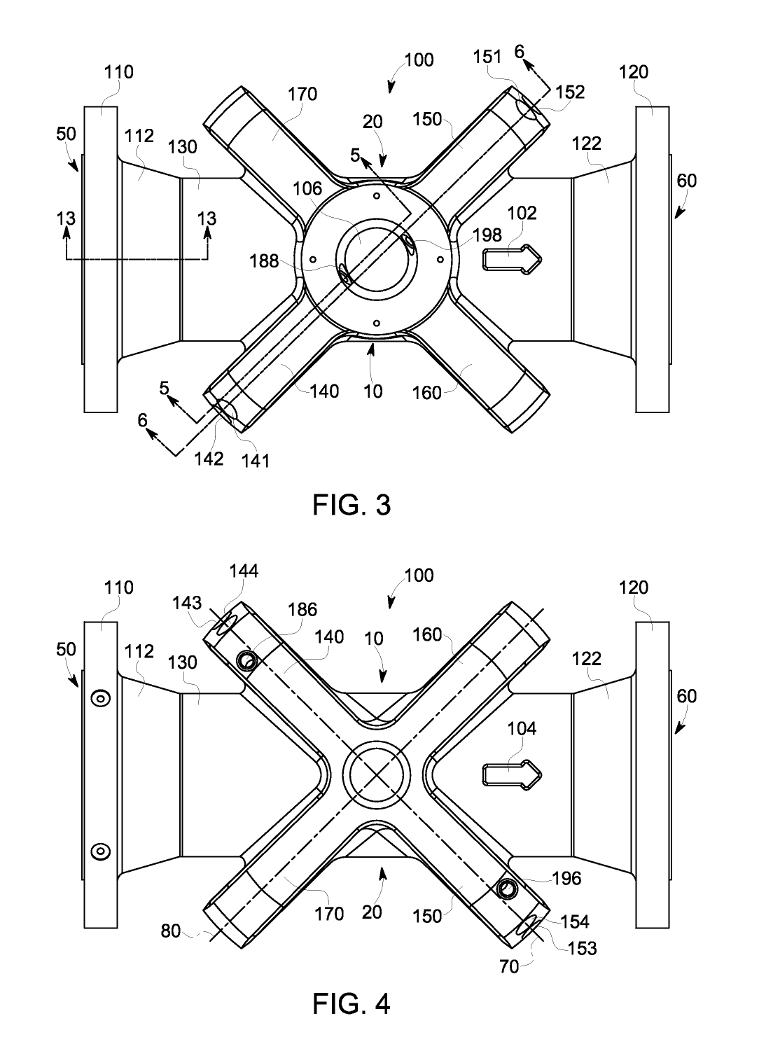

FIGS. 1-4 provide several views of an exemplary flow cell 100, including views of the flow cell's 100 first side 10 (FIG. 1), second side 20 (FIG. 2), top side 30 (FIG. 3), and bottom side 40 (FIG. 4). The exemplary flow cell 100 comprises a first flange 110 at a first end 50 (or downstream end) of the flow cell 100 and a second flange 120 at a second end 60 (or upstream end) of the flow cell 100. A first flow direction arrow 102 on the top side 30 of the flow cell 100 and a second flow direction arrow 104 on the bottom side 40 of the flow cell 100 show the direction that the fluid to be measured will travel in the flow cell 100. A first flange neck 112 connects the first flange 110 to a first end of the sensor body 130, while a second flange neck 122 connects the second flange 120 to a second end of the sensor body 130, which is located between the two flanges 110, 120 and flange necks 112, 122. The first flange 110 and the second flange 120 can connect to the pipes of the system carrying the fluid to be measured (e.g., in a refinery, chemical plant, etc.). A first flange bore 114 extends through the first flange 110 and the first flange neck 112, while a second flange bore 124 extends through the second flange 120 and the second flange neck 122. A sensor body bore 134 extends through the sensor body 130. The fluid to be measured flows through the first flange bore 114, the sensor body bore 134, and the second flange bore 124 of the flow cell.

In one embodiment, the sensor body 130 can include a flow meter cable cavity 106 on the top side 30 of the flow cell 100. A flow meter can be installed on the flow meter cable cavity 106 on the flow cell 100 or can be located remotely from the flow cell 100. The flow meter cable cavity 106 can receive the cables from the sensor assemblies routed internally in the sensor body 130 to communicate with the flow meter as will be described.

The sensor body 130 can include four sensor body quadrants 140, 150, 160, 170 extending outwardly from the sensor body bore 134. In the exemplary flow cell 100, the first sensor body quadrant 140 extends outwardly from the sensor body bore 134 on the first side 10 of the flow cell 100, while the second sensor body quadrant 150 extends outwardly from the sensor body bore 134 on the second side 20 of the flow cell 100, wherein the second side 20 is opposite the first side 10. In the exemplary flow cell 100, the third sensor body quadrant 160 extends outwardly from the sensor body bore 134 on the first side 10 of the flow cell 100, while the fourth sensor body quadrant 170 extends outwardly from the sensor body bore 134 on the second side 20 of the flow cell 100.

The first sensor body quadrant 140 and the second sensor body quadrant 150 of the exemplary flow cell 100 each include four sensor ports in which sensor assemblies (e.g., transducer assemblies, pressure sensor assemblies, temperature sensor assemblies, etc.) can be installed. In one embodiment, transducer assemblies can be installed to form four ultrasonic paths at four chord locations across the sensor body bore 134. In one embodiment, the first sensor body quadrant 140 includes four upstream sensor ports 141, 142, 143, 144 extending through the first sensor body quadrant 140 in the first plane 70, and the second sensor body quadrant 150 includes four downstream sensor ports 151, 152, 153, 154 extending through the second sensor body quadrant 150 in the first plane 70. Each of the sensor ports 141, 142, 143, 144, 151, 152, 153, 154 provides an opening from the exterior of the flow cell 100 to the sensor body bore 134 in which the sensor assemblies can be installed.

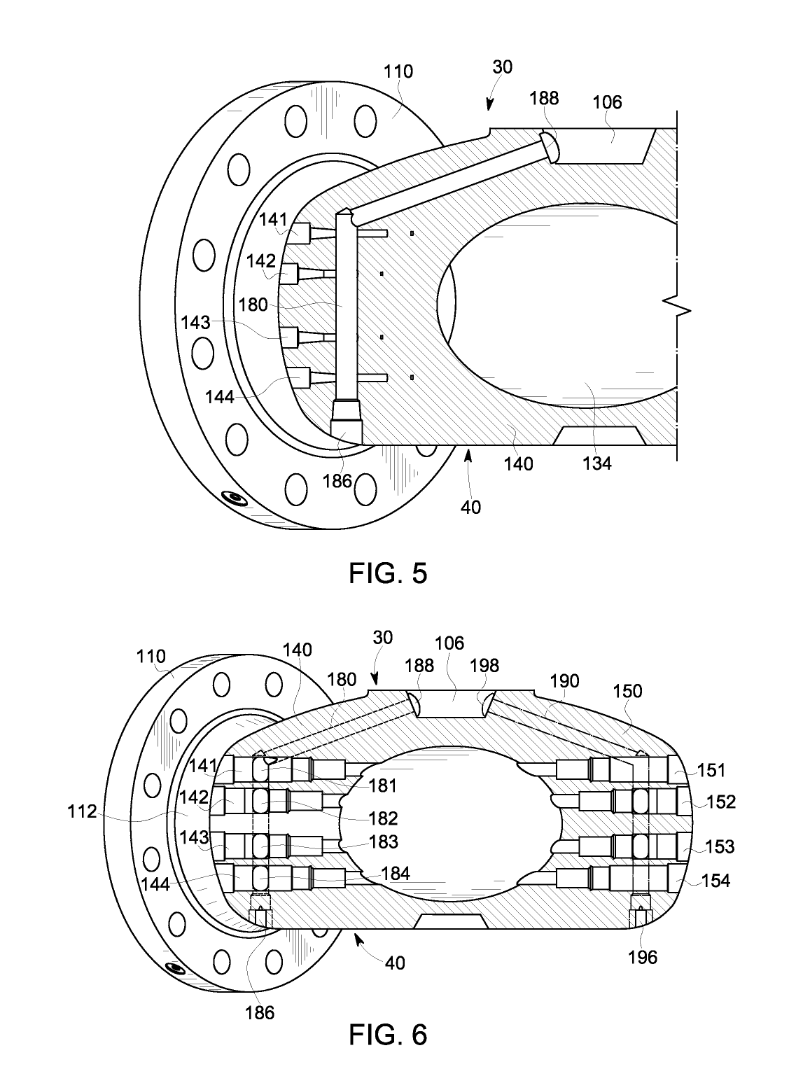

FIGS. 5 and 6 are cross-sections through the first sensor body quadrant 140 and the second sensor body quadrant 150 of the exemplary flow cell 100 illustrating the exemplary first quadrant cable routing channel 180 and the exemplary second quadrant cable routing channel 190 used for routing cables from the upstream sensor ports 141, 142, 143, 144 and the downstream sensor ports 151, 152, 153, 154 to the flow meter cable cavity 106 to communicate with the flow meter. The cable routing channels 180, 190 can be formed by drilling into the flow cell 100 and provide openings from the sensor ports 141, 142, 143, 144, 151, 152, 153, 154 in which the cables are routed internally within the flow cell 100 to communicate with the flow meter. In order to provide access to the cables in the cable routing channels 180, 190, each cable routing channel 180, 190 can have a plurality of access ports. The exemplary first quadrant cable routing channel 180 can extend internally within the first sensor body quadrant 140 of the flow cell 100 from a first access port 186 on the bottom side 40 of the flow cell 100 to a second access port 188 in the flow meter cable cavity 106 on the top side 30 of the flow cell. Similarly, the exemplary second quadrant cable routing channel 190 can extend internally within the first sensor body quadrant 140 of the flow cell 100 from a first access port 196 on the bottom side 40 of the flow cell 100 to a second access port 198 in the flow meter cable cavity 106 on the top side 30 of the flow cell. In other embodiments, the cable routing channels 180, 190 can extend at least from the sensor ports 141, 142, 143, 144, 151, 152, 153, 154 to the flow meter cable cavity 106, but not extend to the bottom of the flow cell 100.

As shown in FIGS. 5 and 6, at least a portion of the first quadrant cable routing channel 180 extends proximate each upstream sensor port 141, 142, 143, 144, which each include a sensor port cable window 181, 182, 183, 184 that provides an opening from the upstream sensor ports 141, 142, 143, 144 to the first quadrant cable routing channel 180 in which the cables from the sensor assemblies in the sensor ports 141, 142, 143, 144 can be routed internally within the flow cell 100 to communicate with the flow meter via the first quadrant cable routing channel 180. For example, a first chord upstream sensor port cable window 181 connects the first chord upstream sensor port 141 to the first quadrant cable routing channel 180, a second chord upstream sensor port cable window 182 connects the second chord upstream sensor port 142 to the first quadrant cable routing channel 180, a third chord upstream sensor port cable window 183 connects the third chord upstream sensor port 143 to the first quadrant cable routing channel 180, and a fourth chord upstream sensor port cable window 184 connects the second chord upstream sensor port 144 to the first quadrant cable routing channel 180.

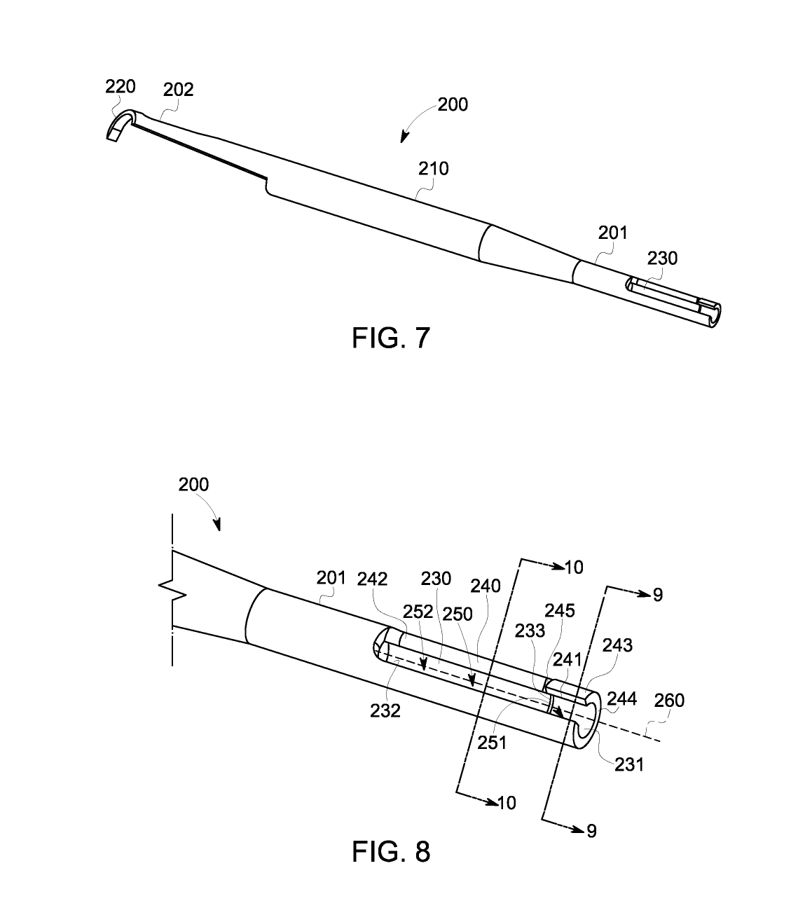

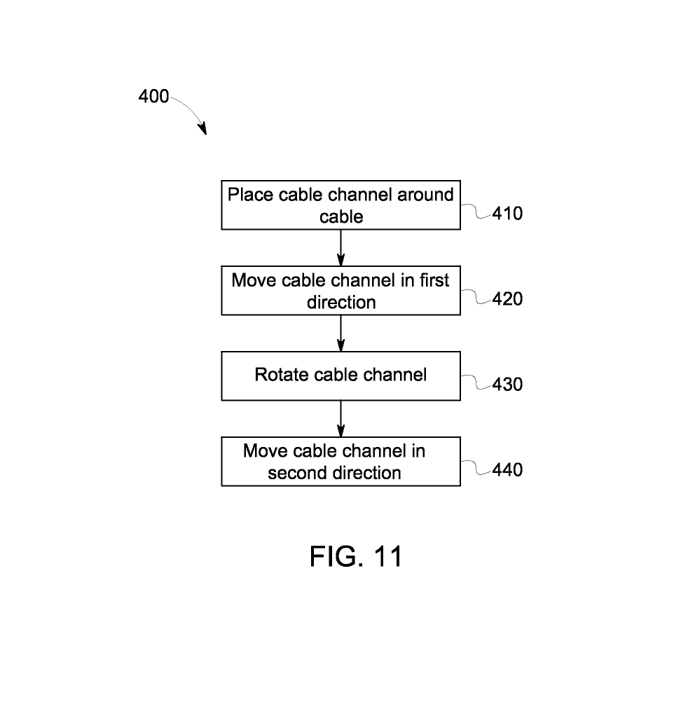

FIG. 7 is perspective view of an exemplary cable tool 200 for installing or removing a cable 300 (e.g., a coaxial cable as shown in FIGS. 11 and 13). In one embodiment, the cable tool 300 can be used in the exemplary flow cell of FIGS. 1-6. The cable tool 200 comprises a handle 210 between a first end 201 and an axially opposite second end 202. The second end 202 of the cable tool 200 includes a cable hook 220 the can be used to route cables through the cable routing channels 180, 190 of the flow cell 100 (FIGS. 5 and 6). The first end 201 of the cable tool 200 includes a cable channel 230 for installing or removing a cable 300 and connecting or disconnecting the cable 300 from a sensor 320 (FIGS. 11 and 13) in the sensor ports 141, 142, 143, 144, 151, 152, 153, 154 of the flow cell 100 (FIG. 6).

FIG. 8 is an enhanced view of the cable channel 230 of the exemplary cable tool 200 of FIG. 7. The exemplary cable channel 230 is formed from a cable channel wall 240 and has a cable channel opening 250 for receiving or releasing the cable 300 from the cable channel 230. The cable channel 230 comprises a first channel 231 at the distal (first) end of the cable channel 230 formed from a first channel wall 241. As shown in FIG. 8 and the cross-section of the first channel 231 shown in FIG. 10, the first channel 231 has a first channel opening 251 extending in radial direction 253. The first channel wall 241 forms a first partial circle between 270 and 360 degrees. As shown in FIG. 8. the first channel wall 241 also includes a first channel wall arm 243 having a front face 244 and a rear face 245.

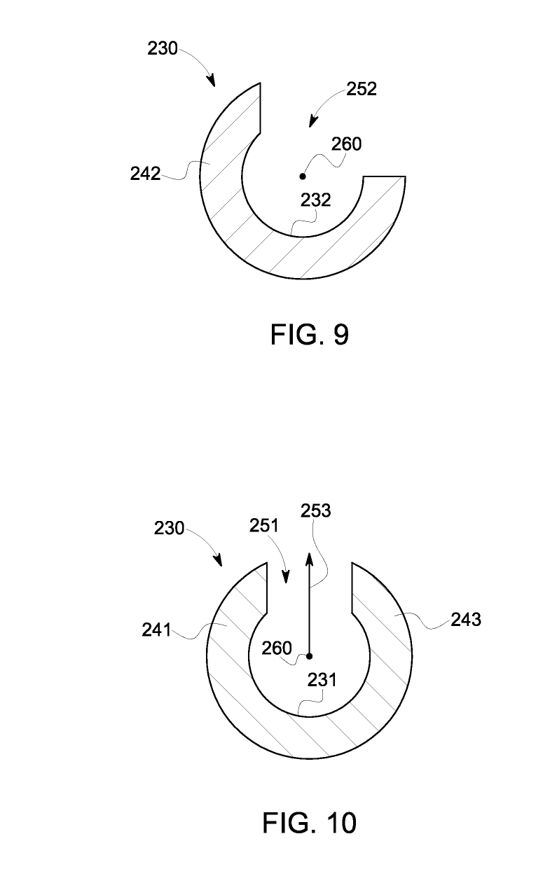

The cable channel 230 also comprises a second channel 232 at the proximal (second) end of the cable channel 230 (opposite of the distal end of the cable channel 230) formed from a second cable channel wall 242. As shown in FIG. 8 and the cross-section of the second channel 232 shown in FIG. 9, the second channel 232 has a second channel opening 252. A second channel wall 242 forms a second partial circle between 180 and 270 degrees. As can be seen from FIG. 8 and a comparison of FIGS. 9 and 10, the length of the first partial circle of the first channel wall 241 (FIG. 10) is greater than the length of the second partial circle of the second channel wall 242 (FIG. 9) by the length of the first channel wall arm 243 extending beyond the second channel wall 242. This results in the first channel opening 251 being smaller than the second channel opening 252.

As can be seen in FIG. 8, in one embodiment, the cable channel 230 also comprises a step 233 between the first channel 231 and the second channel 232. In the exemplary embodiment, the diameter of the first channel 231 is greater than the diameter of the second channel 232, allowing additional space in the first channel 231 to receive, e.g., the heat shrink material associated with the termination of the distal end of the cable 300 with a connector 310 (FIGS. 11 and 13).

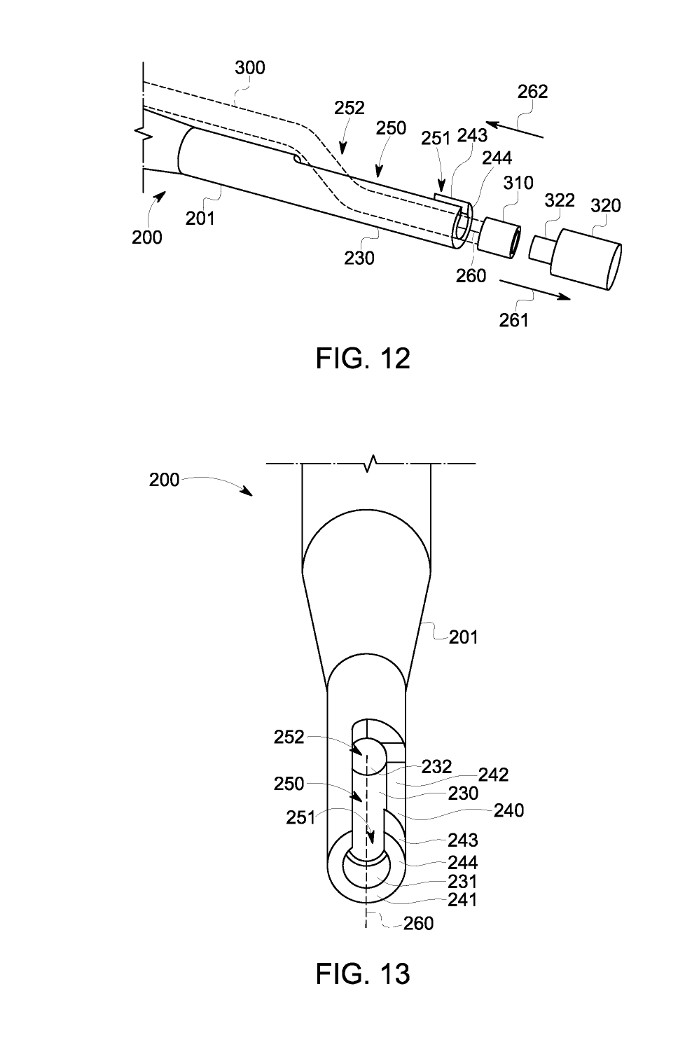

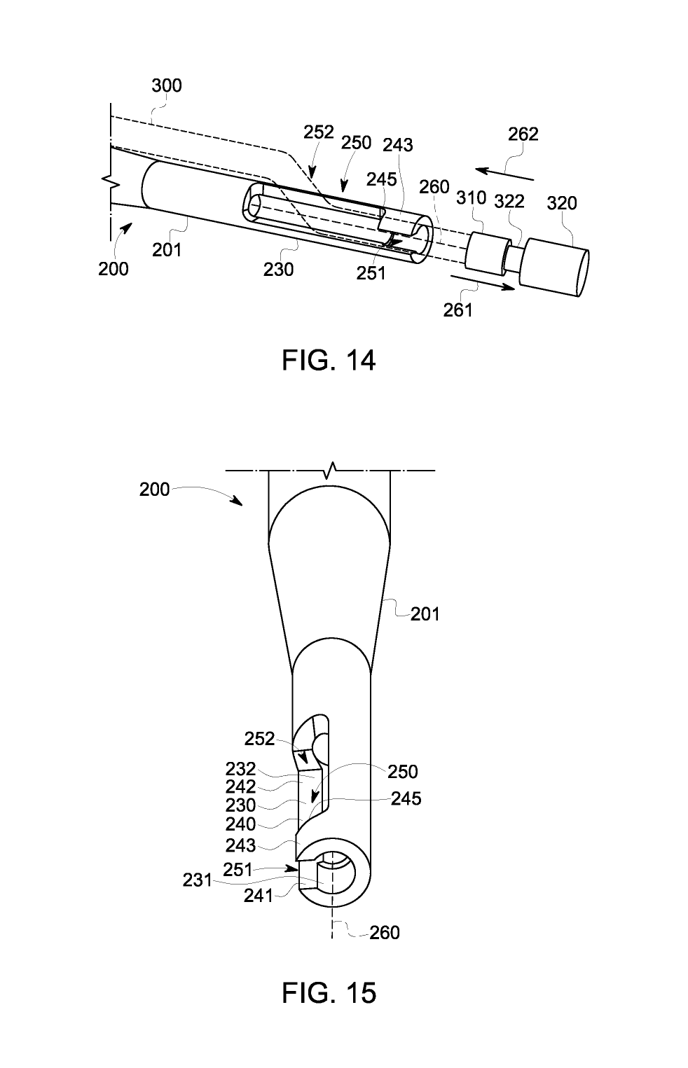

FIG. 11 is an exemplary method 400 for installing or removing a cable using the exemplary cable tool 200 of FIG. 7. To illustrate the exemplary method, FIGS. 12 and 13 are perspective views of the exemplary cable tool 200 of FIG. 7 as used to install a cable 300 and connect the cable connector 310 to a connector 322 of a sensor 320. On the other hand, FIGS. 14 and 15 are perspective views of the exemplary cable tool 200 of FIG. 7 as used to remove the cable 300 and disconnect the cable connector 310 from the connector 322 of the sensor 322.

Referring to FIG. 11, at step 410, the cable channel 230 is placed around the cable 300. At step 420, the cable channel 230 is moved in a first longitudinal direction 261 proximate to the distal end of the cable 300 while surrounding a portion of the cable 300. As shown in FIGS. 12 and 13, the cable channel 230 is advanced until it reaches the distal end of the cable 300 proximate to the cable connector 310. At that point, the front face 244 of the first channel wall arm 243 can be used to push the cable connector 310 (e.g., a snap on coupling connector such as an SMB connector) onto the connector 322 of the sensor 320 by pushing the cable tool 200 in the first longitudinal direction 261. In one embodiment, this step 420 of moving the cable channel 230 in a first longitudinal direction 261 is performed with the first cable channel opening 230 oriented in a vertical radial direction 253 (FIG. 10) (e.g., upward).

As can be seen in FIGS. 12 and 13, once the cable connector 310 is firmly connected to the connector 322 of the sensor 320, the cable tool 200 can be removed from the cable 300 by exerting pressure in a vertical direction (e.g., downward) opposite of the vertical radial direction 253 of the first channel opening 230 such that the portion of the cable 300 in the cable channel 230 is released through the first channel opening 251 and the second channel opening 252. In order to release the cable 300, the horizontal force in the second longitudinal direction 262 produced by the downward pressure applied to remove the cable 300 from the cable channel 230 cannot exceed the pressure required to disconnect the cable connector 310 from the connector 322 of the sensor 320.

Returning to FIG. 11, at step 430, the cable channel 230 can be rotated as shown in the comparison of FIGS. 12 and 13 (where the first channel opening 252 is vertical based on the orientation of the first channel wall arm 243) to FIGS. 14 and 15 (where the first channel opening 252 is horizontal based on the orientation of the first channel wall arm 243). In one embodiment, this change is accomplished by rotating the cable channel 230 clockwise by approximately 90 degrees. As will be explained, this rotation step 430 is done before attempting to remove the cable 300 and disconnect the cable connector 310 from the connector 322 of the sensor 322.

At step 440, the cable channel 230 is moved in a second longitudinal direction 262 opposite of the first longitudinal direction 261 while the cable channel 230 surrounds the portion of the cable 300 at the distal end of the cable 300. Since the cable channel 230 was rotated in step 430, the step 440 of moving the cable channel 230 in a second longitudinal direction 262 is performed with the first cable channel opening 251 oriented in a horizontal radial direction, which is orthogonal to the vertical radial direction used in step 420. As shown in FIG. 14, when the cable channel 230 is rotated, the rear face 245 of the first channel wall arm 243 can be used to pull the cable 300 and its associated cable connector 310 off the connector 322 of the sensor 320. In one embodiment, the rear face 245 is perpendicular to the longitudinal center axis 260 of the cable channel 230, increasing the friction between the first channel wall arm 243 and the cable 300 to facilitate the disconnection of the cable connector 310.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An apparatus for installing or removing a cable, the apparatus comprising:
a first end comprising a cable channel formed from a cable channel wall and having a cable channel opening for receiving or releasing the cable from the cable channel, the cable channel comprising
a first channel at a first end of the cable channel formed from a first channel wall and having a first channel opening, the first channel wall forming a first partial circle and having first channel wall arm having a front face and a rear face, and
a second channel at a second end of the cable channel opposite of the first end the cable channel formed from a second channel wall and having a second channel opening, the second channel wall forming a second partial circle,
wherein the length of the first partial circle of the first channel wall is greater than the length of the second partial circle of the second channel wall by the length of the first channel wall arm extending beyond the second channel wall, and
wherein the first channel opening is smaller than the second channel opening.

2. The apparatus of claim 1, further comprising a step between the first channel and the second channel.

3. The apparatus of claim 2, wherein the diameter of the first channel is greater than the diameter of the second channel.

4. The apparatus of claim 1, wherein the first partial circle is between 270 and 360 degrees.

5. The apparatus of claim 1, wherein the second partial circle is between 180 and 270 degrees.

6. The apparatus of claim 1, wherein the rear face of the first channel wall arm is perpendicular to the longitudinal center axis of the cable channel.

7. The apparatus of claim 1, wherein the apparatus further comprises an axially opposite second end comprising a cable hook.

8. An apparatus for installing or removing a cable, the apparatus comprising:
a first end comprising a cable channel formed from a cable channel wall and having a cable channel opening for receiving or releasing the cable from the cable channel, the cable channel comprising
a first channel at a first end of the cable channel formed from a first channel wall and having a first channel opening, the first channel wall forming a first partial circle between 270 and 360 degrees and having a first channel wall arm having a front face and a rear face, wherein the rear face is perpendicular to the longitudinal center axis of the cable channel, and
a second channel at a second end of the cable channel opposite of the first end the cable channel formed from a second channel wall and having a second channel opening, the second channel wall forming a second partial circle between 180 and 270 degrees,
wherein the length of the first partial circle of the first channel wall is greater than the length of the second partial circle of the second channel wall by the length of the first channel wall arm extending beyond the second channel wall, and
wherein the first channel opening is smaller than the second channel opening.

9. The apparatus of claim 8, further comprising a step between the first channel and the second channel.

10. The apparatus of claim 9, wherein the diameter of the first channel is greater than the diameter of the second channel.

11. The apparatus of claim 8, wherein the apparatus further comprises an axially opposite second end comprising a cable hook.

12. A method for installing or removing a cable, the method comprising the steps of:
placing a cable channel around the cable, the cable channel formed from a cable channel wall and having a cable channel opening for receiving or releasing the cable from the cable channel, the cable channel comprising a first channel at a first end of the cable channel formed from a first channel wall and having a first channel opening, the first channel wall forming a first partial circle and having first channel wall arm having a front face and a rear face, and a second channel at a second end of the cable channel opposite of the first end the cable channel formed from a second channel wall and having a second channel opening, the second channel wall forming a second partial circle;
moving the cable channel in a first longitudinal direction proximate to the distal end of the cable, wherein the cable channel is moved in the first direction while surrounding a portion of the cable;
rotating the cable channel; and
moving the cable channel in a second longitudinal direction opposite of the first longitudinal direction, wherein the cable channel is moved in the second longitudinal direction while surrounding a portion of the cable at the distal end of the cable causing friction between the rear face of the first channel wall arm and the cable.

13. The method of claim 12, wherein the step of moving the cable channel in a first longitudinal direction is performed with the first cable channel opening oriented in a first radial direction and the step of moving the cable channel in a second longitudinal direction is performed with the first cable channel opening oriented in a second radial direction, wherein the first radial direction is different than the second radial direction.

14. The method of claim 13, wherein the first radial direction is orthogonal to the second radial direction.

15. The method of claim 13, wherein the first radial direction is vertical.

16. The method of claim 15, wherein the second radial direction is horizontal.
